(19) United States
(12) Patent Application Publication
(10) Pub. No.: US 2026/0062772 A1
(43) Pub. Date: Mar. 5, 2026

(54) PHASE CHANGE METAL ALLOYS AND THERMAL INTERFACE MATERIAL ASSEMBLY COMBINING A PATTERNED METAL FOIL WITH A PHASE CHANGE METAL ALLOY

(71) Applicant: THE INDIUM CORPORATION OF AMERICA, Clinton, NY (US)

(72) Inventors: Richard McDonough, Canastota, NY (US); Robert N. Jarrett, Clinton, NY (US)

(21) Appl. No.: 19/309,291

(22) Filed: Aug. 25, 2025

Related U.S. Application Data
(60) Provisional application No. 63/688,771, filed on Aug. 29, 2024.
(60) Provisional application No. 63/819,293, filed on Jun. 6, 2025.

(51) Int. Cl. C22C 28/00; C09K 5/06

(52) U.S. Cl. CPC C22C 28/00; C09K 5/06

(57) ABSTRACT

Phase change metal alloys and their uses as thermal interface materials in electronic assemblies are described. In one implementation, a phase change metal alloy includes: 50 wt % to 70 wt % In; at least one of: 20 wt % to 40 wt % Bi and 10 wt % to 50 wt % Sn; and greater than 0 wt % to 5.0 wt % Zn. The phase change metal alloy can also include one or more of: greater than 0 wt % to 5.0 wt % Ga; greater than 0 wt % to 1.0 wt % Ag; greater than 0 wt % to 1.0 wt % Cu; greater than 0 wt % to 1.0 wt % Au; greater than 0 wt % to 0.1 wt % Ni; and greater than 0 wt % to 0.1 wt % Ge.

### CROSS-REFERENCE TO RELATED APPLICATIONS

The present application claims priority to U.S. Provisional Patent Application No. 63/819,293, filed Jun. 6, 2025 and titled “PHASE CHANGE METAL ALLOYS AND THERMAL INTERFACE MATERIAL ASSEMBLY COMBINING A PATTERNED METAL FOIL WITH A PHASE CHANGE METAL ALLOY,” and U.S. Provisional Patent Application No. 63/688,771, filed Aug. 29, 2024 and titled “PHASE CHANGE METAL ALLOYS AND THERMAL INTERFACE MATERIAL ASSEMBLY COMBINING A PATTERNED METAL FOIL WITH A PHASE CHANGE METAL ALLOY.” All of the above-mentioned applications are incorporated herein by reference in their entirety.

### DESCRIPTION OF THE RELATED ART

As the electronics industry evolves, the density of electronic devices continues to increase. More and more circuits are being included on integrated circuit (IC) devices without a corresponding increase in device size. During operation, such IC devices generate substantial amounts of heat. Due to this increase in circuit density, IC devices require a corresponding increase in heat dissipation capabilities. As such, there is a need to meet the increasing heat dissipation requirement of these IC devices to ensure their performance and system reliability.

In some systems, heat is dissipated using a copper heat sink that is mechanically clamped down to a microprocessor chip of an IC device. The heat sink can be directly or remotely cooled. To ensure better heat transfer from the microprocessor chip to the heat sink, a thermally conductive interfacial layer is applied. Existing thermal interface materials (TIMs) include polymer greases, polymer, gels, and solder. Greases and gels suffer from the limitation of low thermal conductivity. Additionally, these polymers degrade with temperature and thermal cycling, resulting in diminished properties during the operating life of the device. Solders that are reflowed entail relatively difficult manufacturing and rework processes that add cost. More advanced TIMs, including phase-change materials (PCMs) and low melting alloys (LMAs), attempt to overcome some of these shortcomings. PCMs remain stable in the interface, but are thicker than the other polymer materials, resulting in poor thermal performance. LMAs form a continuous liquid metal film in the interface at operating temperatures, which provides superior thermal conductivity. However, the oxidation products of all suitable LMAs degrade performance in service.

Metal foils have been tested in the role of a TIM, but the foils have not performed reliably in this application. The foils have not conformed well enough to surface irregularities and deviations from coplanarity, resulting in unacceptable temperature distribution on the microprocessor chip. A textured metal foil, Heat-Spring®, described in U.S. Pat. No. 7,593,228 has been demonstrated as a means to provide compliance to a conductive metal interface. The pattern in a Heat-Spring® creates points of intimate contact between the soft metal foil and the interface surfaces. These points of contact are plastically deformed against the surfaces and uniformly distributed. The configuration allows for good contact at pressures well below the flow stress of the soft metal.

### SUMMARY

The technology described herein is directed to phase change metal alloys suitable for use as TIMs. Some implementations relate to a TIM assembly including a thermally conductive foil and a PCMA with an applied metal layer.

In one embodiment, a phase change metal alloy (PCMA) comprises: 50 wt % to 70 wt % In; at least one of: 20 wt % to 40 wt % Bi, and 10 wt % to 50 wt % Sn; and greater than 0 wt % to 5.0 wt % Zn.

In some implementations, the PCMA consists of 50 wt % to 70 wt % In; at least one of: 20 wt % to 40 wt % Bi, and 10 wt % to 50 wt % Sn; greater than 0 wt % to 5.0 wt % Zn; optionally, one or more of: greater than 0 wt % to 5.0 wt % Ga; greater than 0 wt % to 1.0 wt % Ag; greater than 0 wt % to 1.0 wt % Cu; greater than 0 wt % to 1.0 wt % Au; greater than 0 wt % to 0.1 wt % Ni; and greater than 0 wt % to 0.1 wt % Ge; and optionally, greater than 0 wt % to 3.0 wt % of Co, P, Ti, or some combination thereof.

In some implementations, the PCMA consists of 50 wt % to less than 70 wt % In; 20 wt % to less than 40 wt % Bi; 10 wt % to 20 wt % Sn; greater than 0 wt % to 5.0 wt % Zn; and optionally, one or more of: greater than 0 wt % to 1.0 wt % Ag; greater than 0 wt % to 1.0 wt % Cu; greater than 0 wt % to 1.0 wt % Au; greater than 0 wt % to 0.1 wt % Ni; and greater than 0 wt % to 0.1 wt % Ge.

In some implementations, the PCMA consists of about 52.6 wt % In, about 26.6 wt % Bi, about 19.3 wt % Sn, about 0.8 wt % Zn, about 0.6 wt % Ag, and about 0.1 wt % Cu.

In some implementations, the PCMA consists of about 52.6 wt % In, about 26.6 wt % Bi, about 19.85 wt % Sn, about 0.8 wt % Zn, about 0.14 wt % Cu, about 0.01 wt % Ni, and 20 parts per million (ppm) to 40 ppm Ge.

In some implementations, the PCMA consists of 50 wt % to less than 70 wt % In; 20 wt % to less than 40 wt % Bi; 10 wt % to 20 wt % Sn; and greater than 0 wt % to 5.0 wt % Zn.

In some implementations, the PCMA consists of about 50.4 wt % In, about 31.9 wt % Bi, about 15.9 wt % Sn, and about 1.8 wt % Zn.

In some implementations, the PCMA consists of 55 wt % to 70 wt % In; 25 wt % to 40 wt % Bi; and greater than 0 wt % to 5.0 wt % Zn.

In some implementations, the PCMA consists of about 65.8 wt % In, about 33.2 wt % Bi, and about 1.0 wt % Zn.

In some implementations, the PCMA consists of 50 wt % to 70 wt % In; 20 wt % to less than 50 wt % Sn; greater than 0 wt % to 5.0 wt % Zn; and greater than 0 wt % to 5.0 wt % Ga.

In some implementations, the PCMA consists of about 51.9 wt % In, about 45.7 wt % Sn, about 1.4 wt % Zn, and about 1.0 wt % Ga.

In some implementations, the PCMA consists of about 52.0 wt % In, about 45.9 wt % Sn, about 1.6 wt % Zn, and about 0.5 wt % Ga.

In some implementations, the PCMA consists of 50 wt % to 70 wt % In; 20 wt % to less than 50 wt % Sn; greater than 0 wt % to 5.0 wt % Zn; greater than 0 wt % to 5.0 wt % Ga; and one or more of: greater than 0 wt % to 1.0 wt % Ag; greater than 0 wt % to 1.0 wt % Cu; and greater than 0 wt % to 1.0 wt % Au.

In some implementations, the PCMA consists of 50 wt % to less than 70 wt % In; 20 wt % to less than 40 wt % Bi; 10 wt % to 20 wt % Sn; greater than 0 wt % to 5.0 wt % Zn; and greater than 0 wt % to 5.0 wt % Ga.

In some implementations, the PCMA consists of 50 wt % to less than 70 wt % In; 20 wt % to less than 40 wt % Bi; 10 wt % to 20 wt % Sn; greater than 0 wt % to 5.0 wt % Zn; greater than 0 wt % to 5.0 wt % Ga; and one or more of: greater than 0 wt % to 1.0 wt % Ag; greater than 0 wt % to 1.0 wt % Cu; and greater than 0 wt % to 1.0 wt % Au.

In some implementations, the PCMA consists of 55 wt % to 70 wt % In; 25 wt % to 40 wt % Bi; greater than 0 wt % to 5.0 wt % Zn; and greater than 0 wt % to 5.0 wt % Ga.

In some implementations, the PCMA comprises greater than 0 wt % to 3.0 wt % of Co, P, Ti, or some combination thereof.

In some implementations, the PCMA comprises: 50 wt % to less than 70 wt % In; 20 wt % to less than 40 wt % Bi; 10 wt % to 20 wt % Sn; and greater than 0 wt % to 5.0 wt % Zn.

In some implementations, the PCMA comprises 55 wt % to 70 wt % In; 25 wt % to 40 wt % Bi; and greater than 0 wt % to 5.0 wt % Zn.

In some implementations, the PCMA comprises 50 wt % to 70 wt % In; 20 wt % to less than 50 wt % Sn; and greater than 0 wt % to 5.0 wt % Zn.

In one embodiment, a TIM comprises a thermally conductive metal foil comprising a plurality of first regions and a plurality of second regions, the first regions having a first thickness and the second regions having a second thickness greater than the first thickness and forming a patterned surface on the thermally conductive metal foil; a PCMA configured to be placed on the thermally conductive metal foil such that a first surface of the PCMA is in touching relation with the patterned surface; and a thermally conductive metal layer configured to be placed on a second surface of the PCMA opposite the first surface.

In some implementations, the PCMA is on the thermally conductive metal foil such that the first surface of the PCMA is in touching relation with the patterned surface.

In some implementations, a surface of the thermally conductive metal foil opposite the patterned surface is not patterned.

In some implementations, the patterned surface is a uniform patterned surface.

In some implementations, the patterned surface is a non-uniform patterned surface.

In some implementations, the patterned surface is configured to deform and adapt to irregularities, thereby conforming to shapes of said irregularities, in at least one contact surface of an integrated circuit device.

In some implementations, the PCMA comprises 50 wt % to 70 wt % In; at least one of: 20 wt % to 40 wt % Bi, and 10 wt % to 50 wt % Sn; and greater than 0 wt % to 5.0 wt % Zn.

In some implementations, the thermally conductive metal foil comprises tin or indium; and the thermally conductive metal layer comprises tin or indium.

In some implementations, the PCMA has a thickness from about 2 mil to 12 mil, the thermally conductive metal layer has a thickness from about 4 mil to 16 mil, and the thermally conductive metal foil has a thickness from about 8 mil to 20 mil.

In some implementations, the PCMA is a first ribbon or preform cut from the first ribbon, the thermally conductive metal layer is a second ribbon or preform cut from second ribbon, and the thermally conductive metal foil is a third ribbon or preform cut from the third ribbon.

In some implementations, the thermally conductive metal layer is a cladding applied to the second surface of the PCMA.

In one embodiment, a method comprises placing a TIM assembly between a heat generating device and a heat extracting device, the TIM assembly including a thermally conductive metal foil, a solid form of a PCMA on the thermally conductive metal foil, and a thermally conductive metal layer on the PCMA, and the TIM assembly being placed such that a first surface of the thermally conductive metal foil is in touching relation with a surface of the heat generating device, and a first surface of the thermally conductive metal layer is in touching relation with a surface of the heat extracting device; and after placing the TIM assembly, forming a liquid form of the PCMA by heating the PCMA above a solidus temperature of the PCMA.

In some implementations, placing the TIM assembly between the heat generating device and the heat extracting device comprises placing the thermally conductive metal foil on the heat generating device; and after placing the thermally conductive metal foil on the heat generating device, placing a composite of the thermally conductive metal layer on the PCMA on the heat extracting device.

In some implementations, placing the TIM assembly between the heat generating device and the heat extracting device comprises placing a composite including the thermally conductive metal foil, the PCMA, and the thermally conductive metal layer on the heat generating device.

In some implementations, the composite comprises a first ribbon cutout of the thermally conductive metal foil, a second ribbon cutout of the PCMA, and a third ribbon cutout of the thermally conductive metal layer.

In some implementations, the solid form of the PCMA is placed on the thermally conductive metal foil such that a first surface of the PCMA is in touching relation with a second surface of the thermally conductive metal foil opposite the first surface of the thermally conductive metal foil; the second surface of thermally conductive metal foil is a patterned surface comprising protrusions and cavities between the protrusions; and the liquid form of the PCMA flows into the cavities.

In some implementations, forming the liquid form of the PCMA by heating the PCMA comprises operating the heat generating device.

Other features and aspects of the disclosed technology will become apparent from the following detailed description, taken in conjunction with the accompanying drawings, which illustrate, by way of example, the features in accordance with implementations of the disclosed technology. The summary is not intended to limit the scope of any inventions described herein, which are defined by the claims and equivalents.

### BRIEF DESCRIPTION OF THE DRAWINGS

The present disclosure, in accordance with one or more implementations, is described in detail with reference to the following figures. The figures are provided for purposes of illustration only and merely depict example implementations. Furthermore, it should be noted that for clarity and ease of illustration, the elements in the figures have not necessarily been drawn to scale.

FIG. 1A is a cross-sectional block diagram showing components of a semiconductor assembly before being assembled, including a PCMA as a TIM, in accordance with some implementations of the disclosure.

FIG. 1B is a cross-sectional block diagram showing the components of the semiconductor assembly of FIG. 1A as they are assembled with the PCMA deforming to fill the gap between the surface of a semiconductor die and a heat sink.

FIG. 1C is a cross-sectional block diagram showing the semiconductor assembly of FIG. 1A as it operates.

FIG. 2A shows a differential scanning calorimetry (DSC) curve measured for 50.4In31.9Bi15.9Sn1.8Zn (hereinafter “PCMA1”).

FIG. 2B shows a DSC curve measured for 65.8In33.2Bi1.0Zn (hereinafter “PCMA2”).

FIG. 2C shows a DSC curve measured for 52.6In26.6Bi19.3Sn0.8Zn0.6Ag0.1Cu (hereinafter “PCMA2305”).

FIG. 2D shows a DSC curve measured for 51.9In45.7Sn1.4Zn1.0Ga (hereinafter “PCMA3”).

FIG. 2E shows a DSC curve measured for 52.0In45.9Sn1.6Zn0.5Ga (hereinafter “PCMA4”).

FIG. 2F shows a DSC curve measured for 52.6In26.6Bi19.85Sn0.8Zn0.14Cu0.01Ni (Ge dopant (20-40 ppm)) (hereinafter “PCMA2305+”).

FIG. 3 shows a sample of PCMA2305, in accordance with some implementations of the disclosure.

FIG. 4 includes photographs of samples of PCMA1 and PCMA2 before conducting thermal aging tests, and after thermal aging at 85° C. for seven days in air.

FIG. 5 includes photographs of PCMA1, PCMA2, PCMA2305+, and conventional PCMAs after thermal aging at 85° C. for seven days.

FIG. 6 includes photographs of samples of PCMA1, PCMA2, PCMA3, PCMA4, and comparison alloy 51In/32.5Bi/16.5Sn after conducting thermal cycling tests.

FIG. 7 includes photographs of samples of PCMA1, PCMA2, PCMA2305+, and comparison alloy 51In/32.5Bi/16.5Sn before and after conducting thermal cycling tests.

FIG. 8 includes photographs illustrating shelf-life testing of PCMA2305+.

FIG. 9 is a block diagram illustrating the composite structure of a TIM assembly including a thermally conductive foil and a PCMA with an applied metal layer, in accordance with some implementations of the disclosure.

FIG. 10A shows a cross-sectional view of a single-sided thermally conductive metal foil that can be used with the TIM assembly of FIG. 9, in accordance with some implementations of the disclosure.

FIG. 10B shows cross-sectional views of examples of single-sided thermally conductive metal foils having different types of uniform patterned surfaces, in accordance with some implementations of the present disclosure.

FIG. 10C shows cross-sectional views of examples of single-sided thermally conductive metal foils having different types of non-uniform patterned surfaces, in accordance with some implementations of the present disclosure.

FIG. 11A shows a semiconductor assembly being assembled with the TIM assembly of FIG. 9, in accordance with some implementations of the disclosure.

FIG. 11B shows the semiconductor assembly of FIG. 11A after the PCMA of the TIM assembly melts.

Some of the figures included herein illustrate various implementations of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

The figures are not exhaustive and do not limit the present disclosure to the precise form disclosed.

### DETAILED DESCRIPTION

Although various TIMs have been developed over the years as potential candidates for thermally conductive interfacial layers, they have their limitations. For example, some limitations of Heat-Spring® include: 1) the space between the points of contact are filled with air and provide little heat transfer, 2) the required pressure to increase the contact area is too high for many modern electronic packages and 3) the warpage in many larger dies exceed the compressibility range of the TIM, leaving areas without good contact. LMAs are difficult to contain and are incompatible with the clean room environments of electronic assemblies.

Phase change metal alloys (PCMAs) are metal alloys with a melting temperature that is typically between room temperature (or sometimes lower) and the operating temperature of electronic devices. They can be applied as a TIM in a solid form in the interface between a heat generating component and a heat transferring component. During operation of the electronic device, a PCMA heats up and transitions to a liquid phase. A PCMA can also transition back to a solid phase depending on the operating conditions of the device in which it is used as a TIM. Although PCMAs have been used in limited cases as a TIM, they generally fail due to oxidation or surface defects due to recrystallization, which degrades thermal performance.

The technology described herein is directed to PCMAs suitable for use as TIMs. In accordance with implementations further described below, the PCMAs can include i) a majority of indium, ii) bismuth and/or tin as a secondary element, and iii) zinc as an additive. By virtue of the composition of the PCMAs described herein, the PCMAs can be used as a TIM that provides a compliant, conductive metal interface that overcomes the complexity of a solder TIM. In addition, the PCMAs described herein exhibit improved oxidation resistance and superior recrystallization properties as compared to traditional LMAs and PCMAs. Further still, the PCMAs described herein can be easy to apply and clean room compatible.

The addition of Zinc (Zn) to the PCMAs described herein can improve oxidation resistance, enhance heat-cycle resistance, drop the melting point, and enhance the impact resistance of PCMAs. In some implementations, to take advantage of the Zn included in the PCMA for oxidation resistance, the percentage of Zn should not exceed 5 wt % of the resulting alloy, and more preferably no more than 3 wt % of the resulting alloy. In some implementations, adding small amounts of Ag and/or Cu with the addition of Zn can help to lower the liquidus and solidus temperatures of the alloy, making the resulting alloy even more favorable as a PCMA.

In some implementations, small amounts of Ge and/or Ni can be added as dopants to the alloy. Ge can prevent oxidation of the alloy and prolong shelf life. Ni can form favorable intermetallic compounds (IMCs) with other elemental metals, especially with Cu. These IMCs can give the PCMA a more uniform surface finish (e.g., prevent pitting or troughs) by acting as a uniform matrix of nucleation sites that promotes uniform recrystallization upon solidification.

In some implementations, small amounts of Au can be included in the alloy to promote IMC formation.

In some implementations, the PCMA comprises greater than 50 wt % to less than 70 wt % In, greater than 20 wt % to less than 40 wt % Bi, greater than 10 wt % to less than 20 wt % Sn, and up to 5.0 wt % Zn. In one particular embodiment, the PCMA consists of 50.4In31.9Bi15.9Sn1.8Zn (PCMA1).

In some implementations, the PCMA comprises greater than 50 wt % to less than 70 wt % In, greater than 20 wt % to less than 40 wt % Bi, greater than 10 wt % to less than 20 wt % Sn, up to 5.0 wt % Zn, and one or more of: up to 1.0 wt % Ag, up to 1.0 wt % Cu, up to 1.0 wt % Au, up to 0.1 wt % Ni, and up to 0.1 wt % Ge. In one particular embodiment, the PCMA consists of 52.6In26.6Bi19.3Sn0.8Zn0.6Ag0.1Cu (PCMA2305). In one particular embodiment, the PCMA consists of 52.6In26.6Bi19.85Sn0.8Zn0.14Cu0.01Ni (Ge dopant (20-40 ppm)) (PCMA2305+).

In some implementations, the PCMA comprises 55 wt % to 70 wt % In, 25 wt % to 40 wt % Bi, and up to 5.0 wt % Zn. In one particular embodiment, the PCMA consists of 65.8In33.2Bi1.0Zn (PCMA2).

The above-described PCMAs, which do not contain Gallium (Ga), may be usable with a wider variety of surfaces unlike LMAs (specifically, liquid metal alloys). This may be advantageous as Ga can be corrosive, particularly to aluminum.

However, this is not to say that PCMAs in accordance with the disclosure cannot contain Ga. For example, in some implementations, the PCMA comprises 50 wt % to 70 wt % In, 20 wt % to less than 50 wt % Sn, up to 5.0 wt % Zn, and up to 5.0 wt % Ga. In one particular embodiment, the PCMA consists of 51.9In45.7Sn1.4Zn1.0Ga (PCMA3). In one particular embodiment, the PCMA consists of 52.0In45.9Sn1.6Zn0.5Ga (PCMA4).

In some implementations, the PCMA comprises 50 wt % to 70 wt % In, 20 wt % to less than 50 wt % Sn, up to 5.0 wt % Zn, up to 5.0 wt % Ga, and one or more of: up to 1.0 wt % Ag, up to 1.0 wt % Cu, and up to 1.0 wt % Au.

In some implementations, the PCMA comprises greater than 50 wt % to less than 70 wt % In, greater than 20 wt % to less than 40 wt % Bi, greater than 10 wt % to less than 20 wt % Sn, up to 5.0 wt % Zn, and up to 5.0 wt % Ga.

In some implementations, the PCMA comprises greater than 50 wt % to less than 70 wt % In, greater than 20 wt % to less than 40 wt % Bi, greater than 10 wt % to less than 20 wt % Sn, up 5.0 wt % Zn, up to 5.0 wt % Ga, and one or more of: up to 1.0 wt % Ag, up to 1.0 wt % Cu, and up to 1.0 wt % Au.

In some implementations, the PCMA comprises greater than 50 wt % to less than 70 wt % In, greater than 20 wt % to less than 40 wt % Bi, greater than 10 wt % to less than 20 wt % Sn, up to 5.0 wt % Zn, up to 5.0 wt % Ga, and one or more of: up to 1.0 wt % Ag, up to 1.0 wt % Cu, and up to 1.0 wt % Au.

In some implementations, dopants such as Co, P, and/or Ti can be added to any of the aforementioned PCMAs to help to slow down the rate of oxidation of the PCMA. In some implementations, the dopants can comprise a total of up to 3.0 wt % of the PCMA. In some implementations, the dopants can comprise a total of up to 2.0 wt % of the PCMA. In some implementations, the dopants can comprise a total of up to 1.0 wt % of the PCMA.

In some implementations, the PCMAs described herein can have a thermal conductivity of about 18 W/mK or higher. In some implementations, the PCMAs described herein can have a solidus temperature of about 45° C. or higher, and a liquidus temperature of about 110° C. or lower. In some implementations, the PCMAs described herein can have a solidus temperature of about 58° C. or higher, and a liquidus temperature of about 80° C. or lower. By virtue of this configuration, the PCMA can maintain a solid form for easy placement during semiconductor assembly (e.g., using a pick and place machine). Thereafter, during operation of the semiconductor assembly, the PCMA can melt and conform to the surfaces it is applied to.

In some implementations, the PCMA described herein can be rolled down to a thickness of about 2 mil.

In some implementations, the PCMA can be used as a TIM in an electronics assembly as follows. The PCMA can be placed between a heat-generating surface (e.g., a silicon die) and the heat-extracting component (e.g., heat sink) to form an assembly. The PCMA can be placed in a solid state, using a pick and place tool or machine. The pressure of the heat-extracting component (e.g., heat sink) on the assembly can deform the PCMA when the heat-generating surface is energized to warm to the temperature of the phase change of the PCMA. This allows the PCMA to melt conform to the warpage of both surfaces provided that the PCMA is thick enough to compensate for such warpage. The PCMA can provide a high degree of wetting and extremely low contact resistance while in the liquid phase. When the PCMA is slightly larger than the die surface in this example and melts, it can also act as a self-damming material. PCMAs can be heated to allow them to melt and flow to conform to an initial profile, but the PCMAs can be thicker to allow the alloy to conform to the warpage of the assembly and in some application slightly wider than the heat source/area the PCMA is applied to. After the thermal distortions, the PCMA is molded to the package and can continue to conform if operating temperatures are higher than the phase change temperature of the PCMA. In some implementations, to compensate for warpage (e.g., die warpage), the PCMAs described herein can have a thickness of about 8 mil or greater.

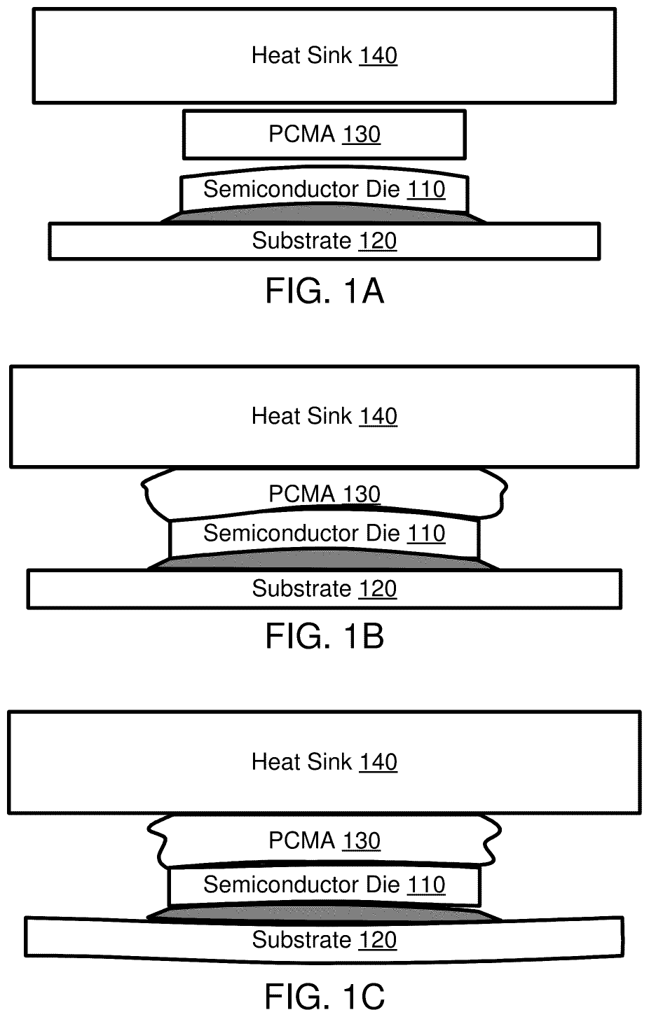

By way of example, FIGS. 1A-1C are cross-sectional block diagrams showing a PCMA 130 as a TIM in a semiconductor assembly, in accordance with some implementations of the disclosure. As depicted by FIG. 1A, a semiconductor die/device 110 connects to a substrate 120, which connects the device to other components. When the semiconductor die 110 is attached to the substrate 120, residual stresses from the assembly cause the thin semiconductor die 110 to curve. A PCMA 130 is inserted between the die 110 and the heat sink 140 to conduct heat generated by the electrical currents from the semiconductor device so it can be passed to ambient. FIG. 1B shows the components of the semiconductor assembly of FIG. 1A as they are assembled with the PCMA 130 deforming to fill the gap between the surface of the semiconductor die 110 and the heat sink 140. FIG. 1C shows the semiconductor assembly as it operates. The heat generated by the semiconductor die 110 expands the substrate 120, which causes the thin semiconductor die 110 and the substrate 120 to change the curvature of the interface between the semiconductor die 110 and the heat sink 140. This change in profile can be absorbed by the PCMA 130 to maintain the heat flow path and cool the die 110.

The PCMAs described herein can be used as a thermal interface in a variety of semiconductor assemblies. For example, in some implementations the PCMAs can be used as a “TIM1” thermal interface between a processor die and heat spreader. In some implementations, the PCMAs described herein can be used as a “TIM1.5” thermal interface in mobile applications or bare die applications where there is no heat spreader, and the die is in direct contact with the cooling solution. In some implementations, the PCMAs described herein can be used as a “TIM2” thermal interface between a heat spreader and heat sink.

PCMAs can be susceptible to severe oxidation when in the liquid state and exposed to high humidity. The use of a barrier and, in some implementations, a hermetic seal, can help to prevent oxidation of the PCMAs during high humidity conditions. In some implementations, a double barrier system can be used to prevent oxidation. One example double barrier system that can be used in implementations of the disclosure is described in U.S. patent application Ser. No. 18/426,144 filed Jan. 29, 2024, and titled “MULTI-BARRIER SYSTEM FOR LOW-VOID THERMAL TRANSFER”, which is incorporated herein by reference in its entirety.

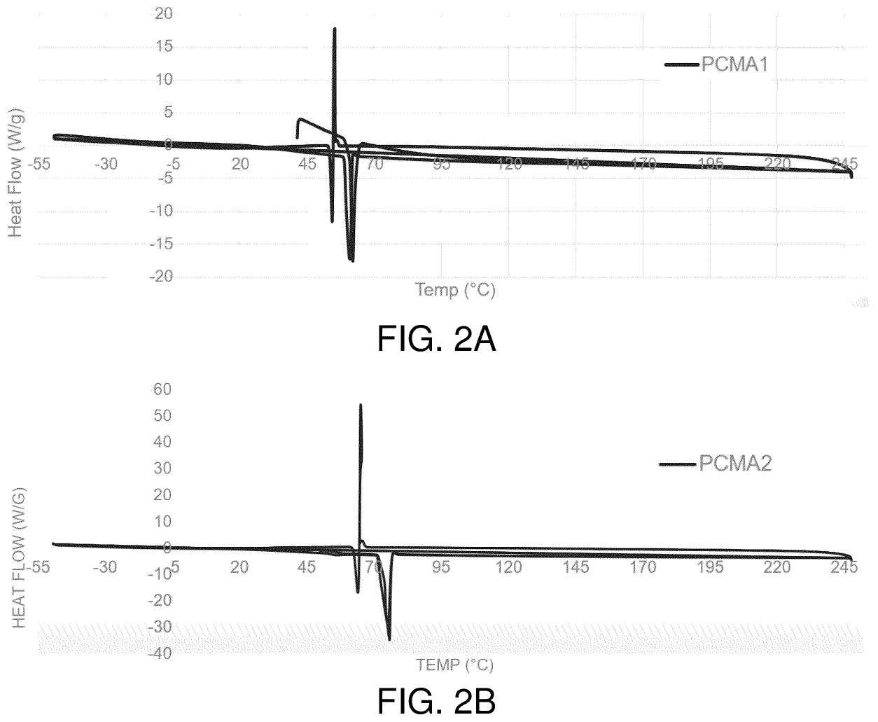

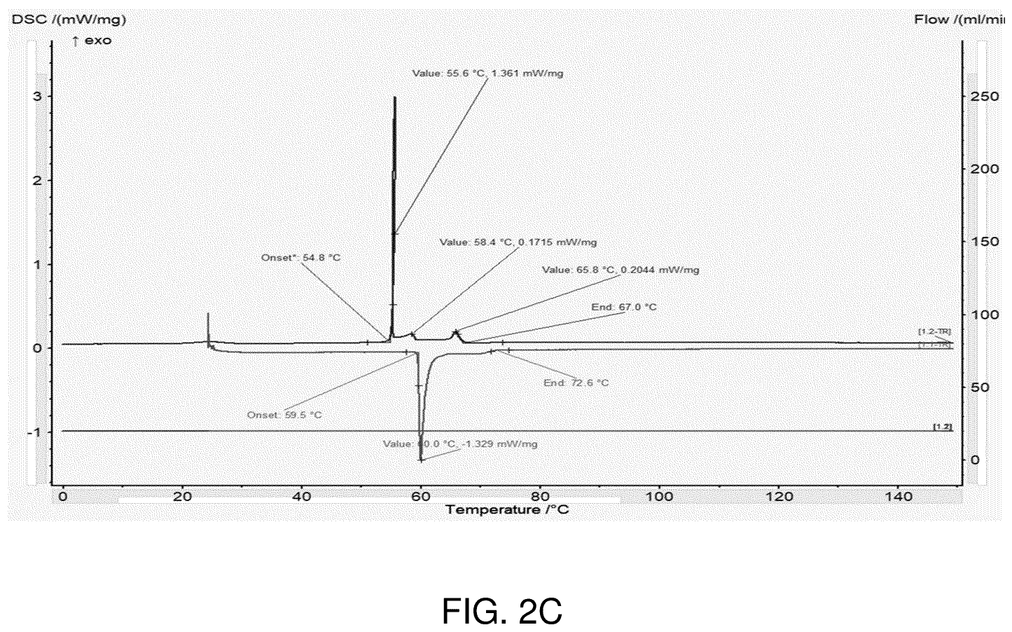

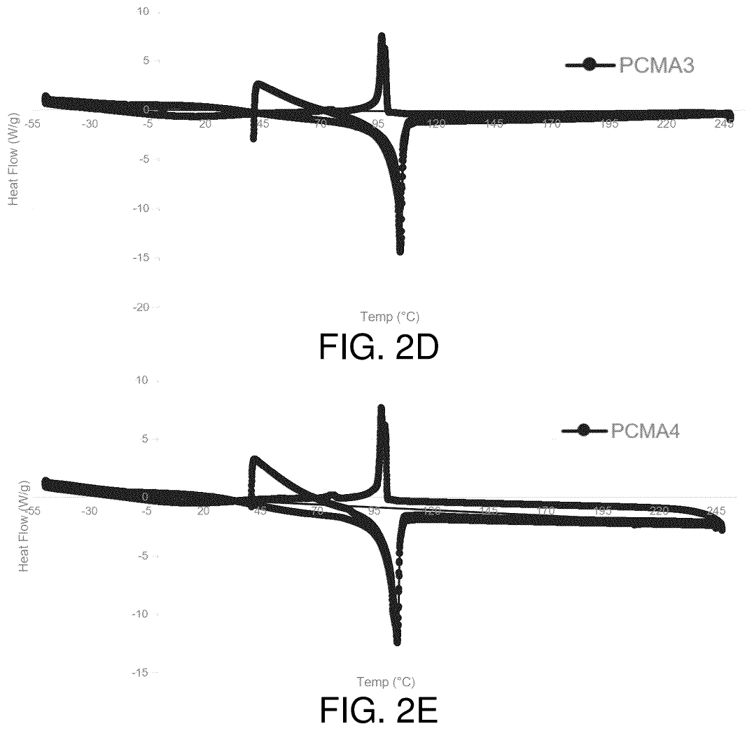

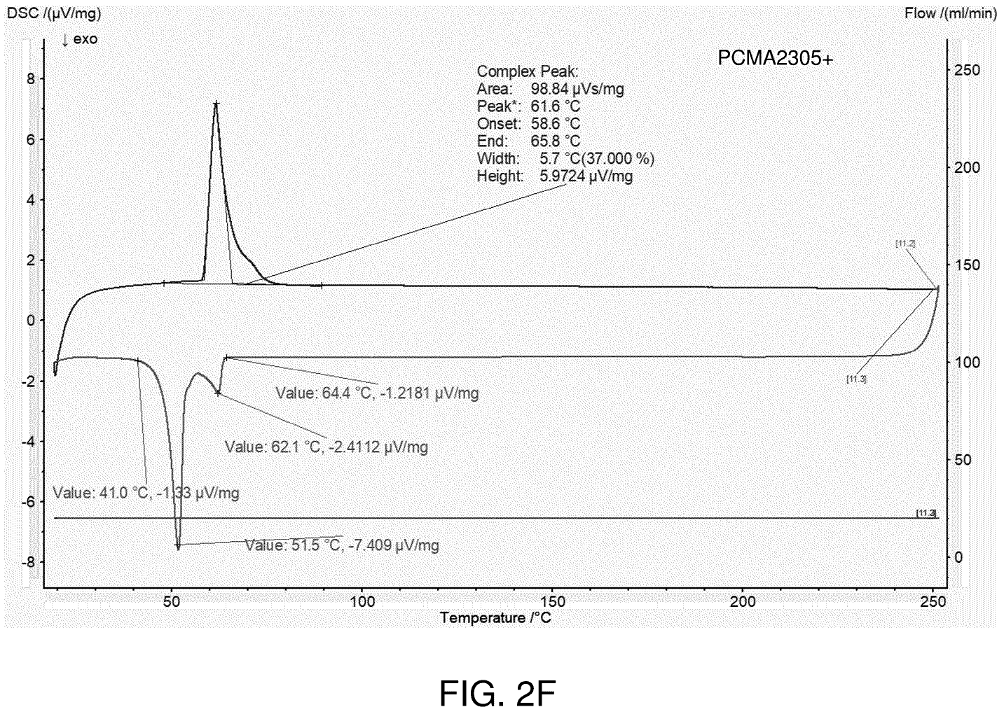

FIG. 2A shows a DSC curve measured for PCMA1. FIG. 2B shows a DSC curve measured for PCMA2. FIG. 2C shows a DSC curve measured for PCMA2305. FIG. 2D shows a DSC curve measured for PCMA3. FIG. 2E shows a DSC curve measured for PCMA4. FIG. 2F shows a DSC curve measured for PCMA2305+. Table 1, below, shows the measured phase change temperatures and thermal conductivities of PCMA1, PCMA2, PCMA 2305, PCMA3, PCMA4, and PCMA2305+. The leftmost temperature in the table corresponds to the measured solidus temperature, and the rightmost temperature in the table corresponds to the measured liquidus temperature.

TABLE 1

| | Phase Change | Thermal Conductivity |
|---|---|---|
| PCMA | Temperature (° C.) | (W/mk) |
| PCMA1 | 58-60 | 21.5 |
| PCMA2 | 71-76 | 22.6 |
| PCMA2305 | 59.5-72.6 | 18.4 |
| PCMA3 | 98-105 | 38 |
| PCMA4 | 100-108 | 35 |
| PCMA2305+ | 58-65 | 19 |

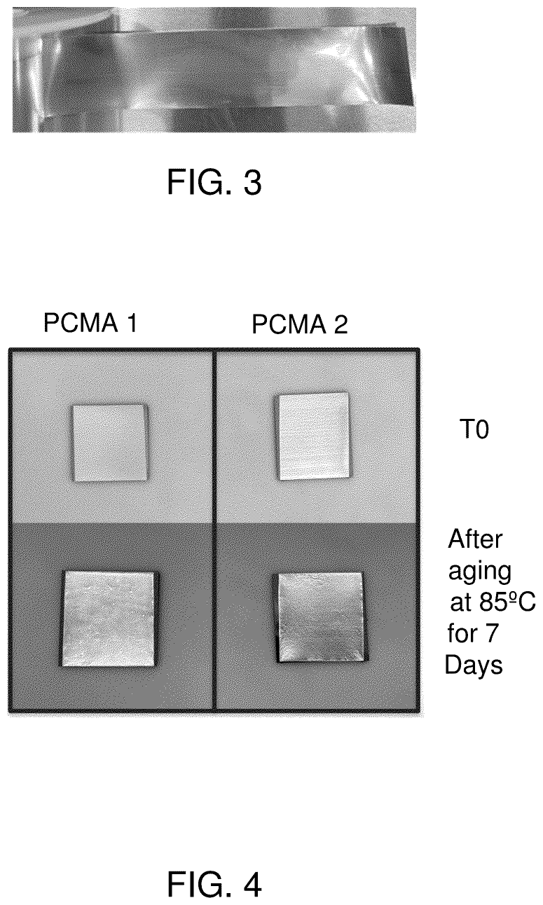

FIG. 3 shows a sample of PCMA2305, in accordance with some implementations of the disclosure. As depicted by FIG. 3, a solid form of the PCMAs described herein can be supplied and rolled on a spool. A suitable preform/sample of the rolled PCMA can be cut from the spool for semiconductor assembly.

FIG. 4 includes photographs of samples of PCMA1 and PCMA2 before conducting thermal aging tests (T0), and after thermal aging at 85° C. for 7 days in air. As illustrated, both PCMAs exhibited excellent oxidation resistance after thermal aging at 85° C. in air. It was also observed that PCMA2 maintained surface integrity even after multiple phase changes.

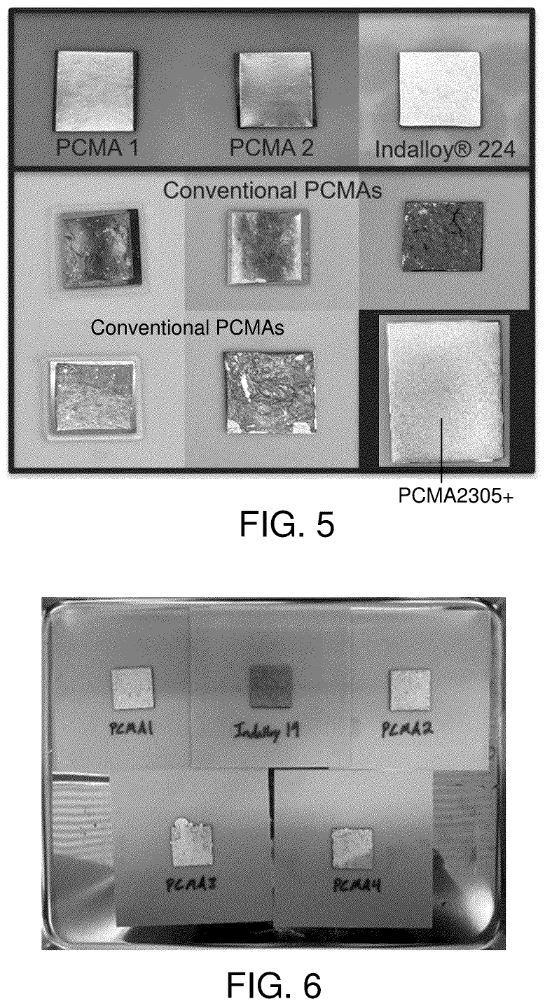

FIG. 5 includes photographs of PCMA1, PCMA2, PCMA2305+, and conventional PCMAs after thermal aging at 85° C. for 7 days. FIG. 5 also shows a photograph of Indalloy® 224 after thermal aging at 150° C. for 7 days. As depicted, PCMA1, PCMA2, and PCMA2305+ outperformed conventional PCMAs, which exhibited significant oxidation after thermal aging. While Indalloy® 224 also performed well, it has a substantially higher melting point than PCMA1, PCMA2, and PCMA2305+.

FIG. 6 includes photographs of samples of PCMA1, PCMA2, PCMA3, PCMA4, and comparison alloy 51In/32.5Bi/16.5Sn (“Indalloy® 19”) after conducting thermal cycling tests. The alloys were subjected to 50 thermal cycles having a temperature range of −40° C. to 150° C. While the PCMAs in accordance with the disclosure showed minimal signs of oxidation, Indalloy19 showed significant signs of oxidation.

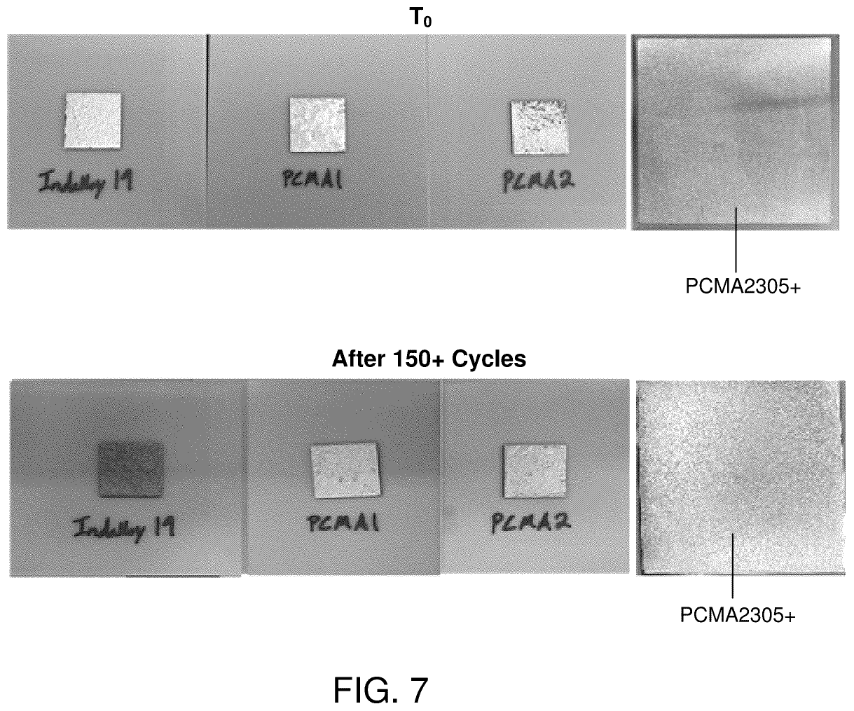

FIG. 7 includes photographs of samples of PCMA1, PCMA2, PCMA2305+, and comparison alloy Indalloy® 19 before (To) and after conducting thermal cycling tests. The alloys were subjected to at least 150 thermal cycles having a temperature range of −40° C. to 150° C. While the PCMAs in accordance with the disclosure showed minimal signs of oxidation and good surface quality, Indalloy19 showed significant signs of oxidation. For example, the surface integrity of the PCMA2 remained the same after the tests. PCMA2305+ showed minimal signs of oxidation and a good surface quality after the thermal tests.

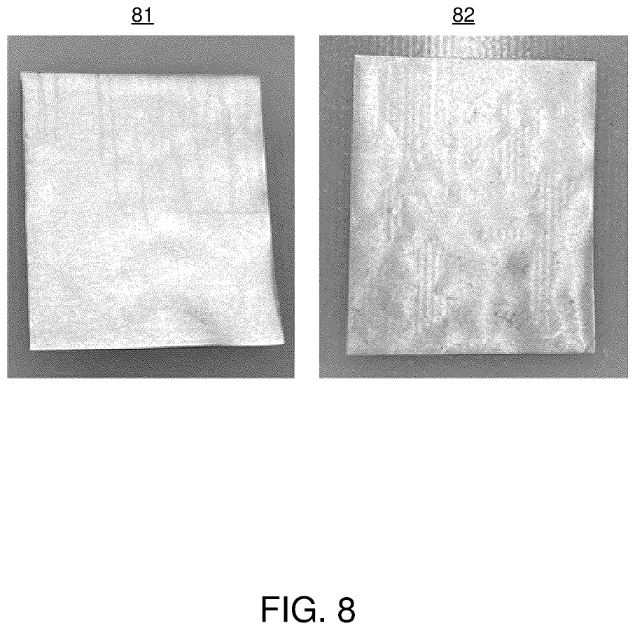

FIG. 8 includes photographs illustrating shelf-life testing of PCMA2305+. Photograph 81 shows a sample after it was made by placing PCMA2305+ on a FR4 substrate. Photograph 82 shows the same sample about 9 months later, after it was left in open air. As shown, there were no signs of oxidation after 9 months.

TIM Assembly Combining PCMA with Thermally Conductive Metal Foil

In one embodiment, a PCMA with an applied metal layer can be used in combination with a thermally conductive foil as a TIM assembly. The TIM assembly can combine the benefits of the properties of a PCMA, with a thermally conductive metal foil that molds to the surface the PCMA assembly, adapting to the thermally induced distortions typical of electronic devices.

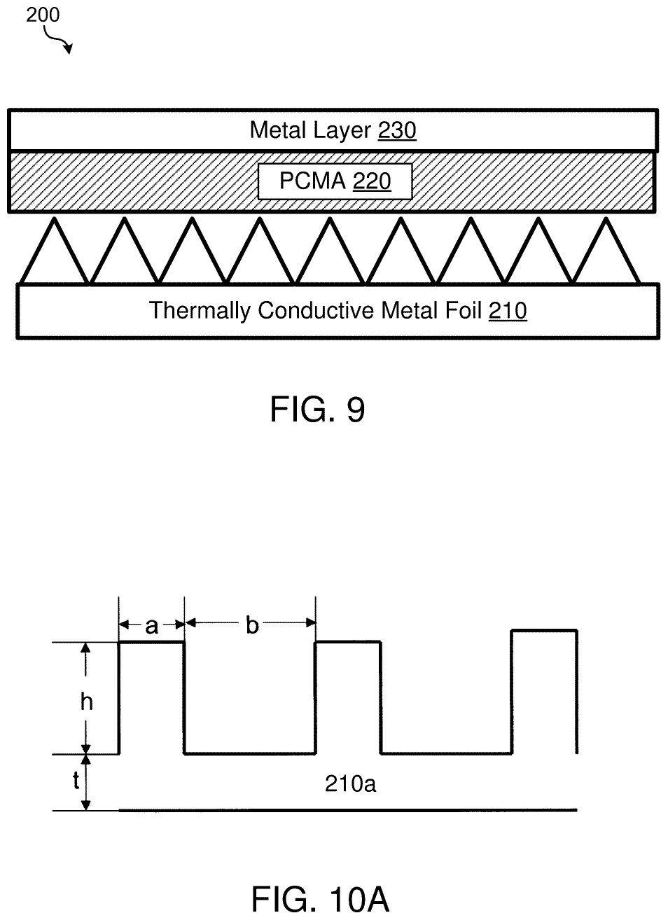

FIG. 9 is a block diagram illustrating the composite structure of such a TIM assembly 200 in accordance with some implementations of the disclosure. The TIM assembly 200 includes a thermally conductive metal foil 210 adjacent to a surface of the PCMA 220 with a metal layer 230 applied on an opposite surface of the PCMA 220. The metal layer 230 can be made of a suitable metal or metal alloy material, composed of a soft metal or metal alloy that has a higher melting point than the PCMA 220. Some suitable metals that can be included in the pliable metal layer 230 include indium, tin, or other soft metals. The metal layer 230 applied on PCMA 220 can create a preform having improved oxidation resistance over the PCMA 220 by itself. This could enable use of a wider variety of PCMAs other than those described above with reference to FIGS. 1-8. As such, while some implementations of the TIM assembly 200 could be used with PCMAs previously described, it should be appreciated that other PCMAs could be used with TIM assembly 200. In some implementations, the metal layer 230 is a metal cladding applied to PCMA 220. For example, the metal cladding can be applied to a top surface of PCMA 220 using known cladding techniques. In other implementations, metal layer 230 is a separate metal ribbon. For example, in some implementations, further described below, three individual ribbons that are layered—one of thermally conductive metal foil 210, one of PCMA 220, and one of metal layer 230—can be punched or otherwise cut together during preparation of TIM assembly 200.

To take advantage of the clad PCMA 220 for oxidation resistance, the TIM assembly 200 incorporates the compliant behavior of a thermally conductive metal foil 210 with the protective metal layer 230 (e.g., clad coating). In this case, the texture of the thermally conductive metal foil 210 is used to conform to the initial curvature of the interface. Example thermally conductive metal foils 210 that can be used in TIM assembly 200 are further described in U.S. Pat. No. 7,593,228, which is incorporated herein by reference in its entirety.

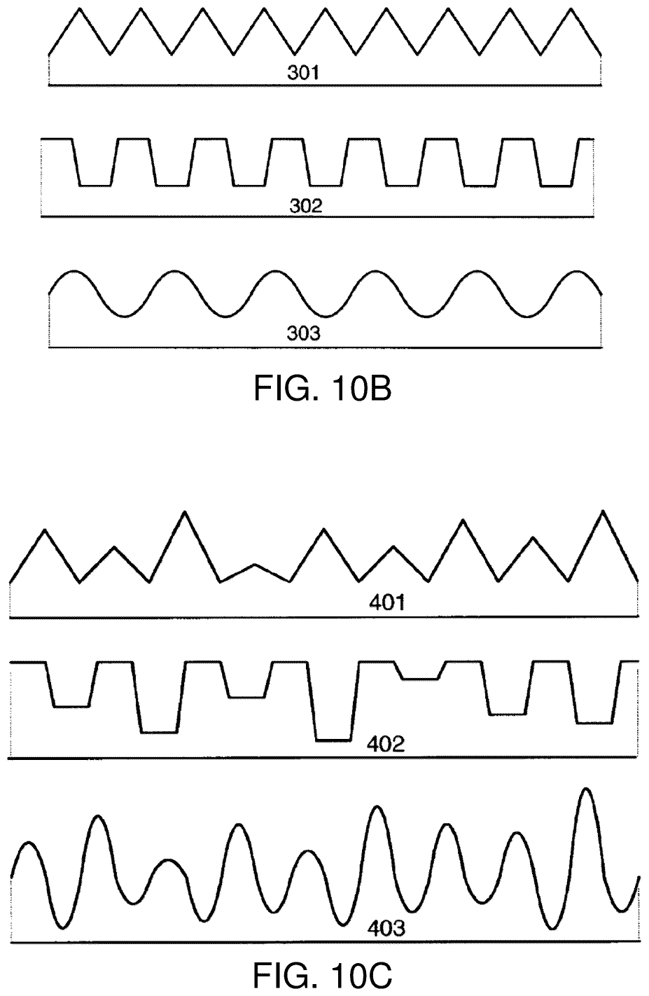

For example, FIG. 10A shows a cross-sectional view of a single-sided thermally conductive metal foil 210a that can be used. The metal foil 210a can be fabricated to have a surface texture that markedly alters the thickness of sections of the metal foil 210a to produce a pattern of peaks and valleys that may be characterized by height (h) of peaks, width of peaks (a), width of valleys (b), and thickness (t) of base material. The pattern can be generated by roll forming or pressing the metal foil 210a, but the pattern can also be generated by other chemical or physical methods. Although FIG. 10A illustrates the metal foil 210a as having a pattern that is simplified and regular, in application the pattern can be uniform or random, and can be linear or a two-dimensional projection with equivalent response. The metal foil 210a can have softness exemplified by alloys of indium, tin, and other malleable metals, and/or composites comprising layers of at least one malleable metal alloy.

FIG. 10B shows cross-sectional views of some examples of single-sided thermally conductive metal foils having different types of uniform patterned surfaces, in accordance with some implementations of the present disclosure. The examples include a metal foil 301 having a uniform saw tooth patterned surface, a metal foil 302 having a uniform square wave patterned surface, and a metal foil 303 having a uniform sinusoidal patterned surface. Other single-sided thermally conductive metal foils having different types of uniform patterned surfaces are also possible in accordance with additional implementations of the present disclosure.

FIG. 10C shows cross-sectional views of multiple examples of single-sided thermally conductive metal foils having different types of non-uniform patterned surfaces, in accordance with some implementations of the present disclosure. The examples include a metal foil 401 having a non-uniform saw tooth patterned surface, a metal foil 402 having a non-uniform square wave patterned surface, and a metal foil 403 having a non-uniform sinusoidal patterned surface. Other single-sided thermally conductive metal foils having different types of non-uniform patterned surfaces are also possible in accordance with additional implementations of the present disclosure.

In some implementations, the PCMA 220 can have a thickness ranging from about 2 mil to 12 mil. In some implementations, the metal layer 230 can have a thickness ranging from about 4 mil to 16 mil. In some implementations, the thermally conductive metal foil 210 can have a thickness ranging from about 8 mil to 20 mil.

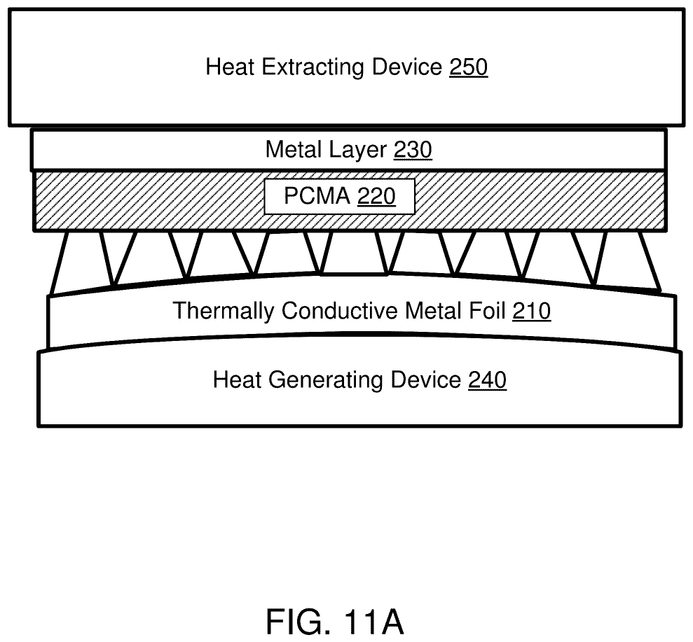

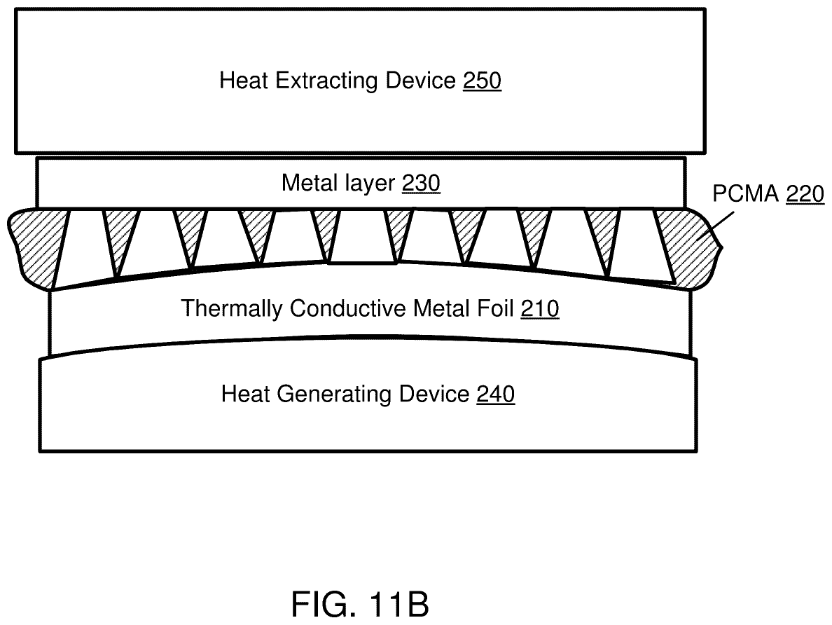

FIG. 11A shows use of TIM assembly 200 with a semiconductor assembly, in accordance with some implementations of the disclosure. As depicted, the TIM assembly 200 can be placed between surfaces of a heat generating device 240 and heat extracting device 250. For example, the heat-generating surface can correspond to a semiconductor die, and the heat extracting device 250 can correspond to a heat sink. As depicted in this example, a single-sided thermally conductive metal foil 210 of TIM assembly 200 is placed on the surface of the heat generating device 240 with the pattern of foil 210 facing up toward the PCMA 220. In some implementations, a composite of PCMA 220 with metal layer 230 (e.g., a PCMA 220 with metal cladding) is placed on thermally conductive metal foil 210. In this example, the metal layer 230 (e.g., the cladding side) presses against heat extracting device 250. This configuration of TIM assembly 200 can be installed as a two-part assembly (i.e., metal foil 210 followed by the PCMA with metal layer).

In some implementations, the TIM assembly 200 can be applied as a single assembly. For example, three individual ribbons that are layered—one of thermally conductive metal foil 210, one of PCMA 220, and one of metal layer 230—can be punched together. The three ribbons could be placed into the punch press at the same time, and all three layers could be punched together. An advantage of this implementation is that it can provide additional efficiency and consistency during the process of preparing and installing TIM assembly 200.

Following application of TIM assembly 200 on heat generating device 240, the heat extracting device 250 (e.g., heat sink) can be installed to complete the semiconductor assembly. The pressure of the heat extracting device 250 on the TIM assembly 200 can deform the pattern of the thermally conductive metal foil 210 to the contour of the interface. In preferred implementations, the heat-generating surface of heat-generating device 240 can be energized to warm to the temperature of the phase change of PCMA 220. This allows the PCMA 220 to melt and fuse to the protrusions of the thermally conductive metal foil 210. When the PCMA 220 melts, it can flow into the interstices of the pattern of foil 210 and fill the empty spaces. This is depicted by FIG. 11B, which shows that with the application of heat, the PCMA 220 can flow to fill the gaps in the interface, replacing air.

As the foregoing example illustrates, the composite structure includes pillars of soft metal of the foil surround by a PCMA. The height of the pillars can match the interface profile. When the interface is stressed by thermal excursions, the pillars can provide a compliant structure to maintain contact across the interface. If the thermal load is sufficient, the PCMA can melt, and the soft metal can conform to the interface. Because the alloy is saturated with the soft metal composition, the solid and liquid structures can remain stable during operation of the semiconductor device.

As used herein, the term “about” is used to describe and account for small variations in a numerical parameter, for example, due to rounding of the numerical parameter. For example, in quantitative terms, the term “about” can refer to less than or equal to ±5%, less than or equal to ±2%, less than or equal to ±1%, less than or equal to ±0.5%, less than or equal to ±0.2%, less than or equal to ±0.1%, and less than or equal to ±0.05%. Moreover, where “about” is used herein in conjunction with a numerical parameter it is understood that the exact value of the numerical parameter is also contemplated and described. For example, the term “about 10” expressly contemplates, describes and includes exactly 10.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

It should be appreciated that all combinations of the foregoing concepts (provided such concepts are not mutually inconsistent) are contemplated as being part of the inventive subject matter disclosed herein. In particular, all combinations of claimed subject matter appearing in this disclosure are contemplated as being part of the inventive subject matter disclosed herein.

What is claimed is:

1. A phase change metal alloy (PCMA), comprising:
50 wt % to 70 wt % In;
at least one of:
20 wt % to 40 wt % Bi, and
10 wt % to 50 wt % Sn; and
greater than 0 wt % to 5.0 wt % Zn.

2. The PCMA of claim 1, consisting of:
50 wt % to 70 wt % In;
at least one of:
20 wt % to 40 wt % Bi, and
10 wt % to 50 wt % Sn;
greater than 0 wt % to 5.0 wt % Zn;
optionally, one or more of:
greater than 0 wt % to 5.0 wt % Ga;
greater than 0 wt % to 1.0 wt % Ag;
greater than 0 wt % to 1.0 wt % Cu;
greater than 0 wt % to 1.0 wt % Au;
greater than 0 wt % to 0.1 wt % Ni; and
greater than 0 wt % to 0.1 wt % Ge; and
optionally, greater than 0 wt % to 3.0 wt % of Co, P, Ti, or some combination thereof.

3. The PCMA of claim 2, consisting of:
50 wt % to less than 70 wt % In;
20 wt % to less than 40 wt % Bi;
10 wt % to 20 wt % Sn;
greater than 0 wt % to 5.0 wt % Zn; and
optionally, one or more of:
greater than 0 wt % to 1.0 wt % Ag;
greater than 0 wt % to 1.0 wt % Cu;
greater than 0 wt % to 1.0 wt % Au;
greater than 0 wt % to 0.1 wt % Ni; and
greater than 0 wt % to 0.1 wt % Ge.

4. The PCMA of claim 3, wherein the PCMA consists of about 52.6 wt % In, about 26.6 wt % Bi, about 19.3 wt % Sn, about 0.8 wt % Zn, about 0.6 wt % Ag, and about 0.1 wt % Cu.

5. The PCMA of claim 3, wherein the PCMA consists of about 52.6 wt % In, about 26.6 wt % Bi, about 19.85 wt % Sn, about 0.8 wt % Zn, about 0.14 wt % Cu, about 0.01 wt % Ni, and 20 parts per million (ppm) to 40 ppm Ge.

6. The PCMA of claim 3, consisting of:
50 wt % to less than 70 wt % In;
20 wt % to less than 40 wt % Bi;
10 wt % to 20 wt % Sn; and
greater than 0 wt % to 5.0 wt % Zn.

7. The PCMA of claim 6, wherein the PCMA consists of about 50.4 wt % In, about 31.9 wt % Bi, about 15.9 wt % Sn, and about 1.8 wt % Zn.

8. The PCMA of claim 2, consisting of:
55 wt % to 70 wt % In;
25 wt % to 40 wt % Bi; and
greater than 0 wt % to 5.0 wt % Zn.

9. The PCMA of claim 8, wherein the PCMA consists of about 65.8 wt % In, about 33.2 wt % Bi, and about 1.0 wt % Zn.

10. The PCMA of claim 2, consisting of:
50 wt % to 70 wt % In;
20 wt % to less than 50 wt % Sn;
greater than 0 wt % to 5.0 wt % Zn; and
greater than 0 wt % to 5.0 wt % Ga.

11. The PCMA of claim 10, wherein the PCMA consists of about 51.9 wt % In, about 45.7 wt % Sn, about 1.4 wt % Zn, and about 1.0 wt % Ga.

12. The PCMA of claim 10, wherein the PCMA consists of about 52.0 wt % In, about 45.9 wt % Sn, about 1.6 wt % Zn, and about 0.5 wt % Ga.

13. The PCMA of claim 2, consisting of:
50 wt % to 70 wt % In;
20 wt % to less than 50 wt % Sn;
greater than 0 wt % to 5.0 wt % Zn;
greater than 0 wt % to 5.0 wt % Ga; and
one or more of:
greater than 0 wt % to 1.0 wt % Ag;
greater than 0 wt % to 1.0 wt % Cu; and
greater than 0 wt % to 1.0 wt % Au.

14. The PCMA of claim 2, consisting of:
50 wt % to less than 70 wt % In;
20 wt % to less than 40 wt % Bi;
10 wt % to 20 wt % Sn;
greater than 0 wt % to 5.0 wt % Zn; and
greater than 0 wt % to 5.0 wt % Ga.

15. The PCMA of claim 2, consisting of:
50 wt % to less than 70 wt % In;
20 wt % to less than 40 wt % Bi;
10 wt % to 20 wt % Sn;
greater than 0 wt % to 5.0 wt % Zn;
greater than 0 wt % to 5.0 wt % Ga; and
one or more of:
greater than 0 wt % to 1.0 wt % Ag;
greater than 0 wt % to 1.0 wt % Cu; and
greater than 0 wt % to 1.0 wt % Au.

16. The PCMA of claim 2, consisting of:
55 wt % to 70 wt % In;
25 wt % to 40 wt % Bi;
greater than 0 wt % to 5.0 wt % Zn; and
greater than 0 wt % to 5.0 wt % Ga.

17. The PCMA of claim 2, wherein the PCMA comprises greater than 0 wt % to 3.0 wt % of Co, P, Ti, or some combination thereof.

18. The PCMA of claim 1, comprising:
50 wt % to less than 70 wt % In;
20 wt % to less than 40 wt % Bi;
10 wt % to 20 wt % Sn; and
greater than 0 wt % to 5.0 wt % Zn.

19. The PCMA of claim 1, comprising:
55 wt % to 70 wt % In;
25 wt % to 40 wt % Bi; and
greater than 0 wt % to 5.0 wt % Zn.

20. The PCMA of claim 1, comprising:
50 wt % to 70 wt % In;
20 wt % to less than 50 wt % Sn; and
greater than 0 wt % to 5.0 wt % Zn.

21. A thermal interface material (TIM) assembly, comprising:
a thermally conductive metal foil comprising a plurality of first regions and a plurality of second regions, the first regions having a first thickness and the second regions having a second thickness greater than the first thickness and forming a patterned surface on the thermally conductive metal foil;
a phase change metal alloy (PCMA) configured to be placed on the thermally conductive metal foil such that a first surface of the PCMA is in touching relation with the patterned surface; and
a thermally conductive metal layer configured to be placed on a second surface of the PCMA opposite the first surface.

22. A method, comprising:
placing a thermal interface material (TIM) assembly between a heat generating device and a heat extracting device, the TIM assembly including a thermally conductive metal foil, a solid form of a phase change metal alloy (PCMA) on the thermally conductive metal foil, and a thermally conductive metal layer on the PCMA, and the TIM assembly being placed such that a first surface of the thermally conductive metal foil is in touching relation with a surface of the heat generating device, and a first surface of the thermally conductive metal layer is in touching relation with a surface of the heat extracting device; and
after placing the TIM assembly, forming a liquid form of the PCMA by heating the PCMA above a solidus temperature of the PCMA.
